(19) United States
(12) Patent Application Publication
(10) Pub. No.: US 2025/0149636 A1
(43) Pub. Date: May 8, 2025

(54) LITHIUM ION BATTERY

(71) Applicant: TOYOTA JIDOSHA KABUSHIKI KAISHA, Aichi-ken (JP)

(72) Inventor: Kazuya TAKEUCHI, Sunto-gun (JP)

(21) Appl. No.: 18/925,025

(22) Filed: Oct. 24, 2024

(30) Foreign Application Priority Data
Nov. 2, 2023 (JP) 2023-188876

(51) Int. Cl. H01M 10/0569; H01M 10/0525; H01M 10/0567; H01M 10/0568

(52) U.S. Cl. CPC H01M 10/0569; H01M 10/0525; H01M 10/0567; H01M 10/0568; H01M 2300/0037

(57) ABSTRACT

Disclosed is a lithium ion battery in which elution of aluminum from an aluminum-containing current collector to an electrolytic solution is suppressed. The lithium ion battery of the present disclosure comprises a positive electrode, a negative electrode and an electrolytic solution, in which one or both of the positive electrode and the negative electrode comprise an aluminum-containing current collector, the aluminum-containing current collector is in contact with the electrolytic solution, the electrolytic solution contains a cyclic carbonate and a lithium amide salt dissolved in the cyclic carbonate, the lithium amide salt contains a chain lithium amide salt and a cyclic lithium amide salt, a molar ratio of the chain lithium amide salt to the cyclic carbonate is greater than 0.25 and 0.33 or less, and a molar ratio of the cyclic lithium amide salt to the cyclic carbonate is greater than 0 and 0.07 or less.

### FIELD

The present application discloses a lithium ion battery.

### BACKGROUND

PTL 1 discloses a lithium ion conducting material comprising a cyclic carbonate as a solvent and a lithium amide salt dissolved in the cyclic carbonate, wherein a molar ratio of the lithium amide salt to the cyclic carbonate is greater than 0.25 and 0.33 or less. The lithium ion conducting material disclosed in PTL 1 can be used, for example, as an electrolytic solution for lithium ion batteries.

### CITATION LIST

### Patent Literature

[PTL 1] Japanese Unexamined Patent Publication No. 2023-138137

### SUMMARY

### Technical Problem

There is a room for improvement on the conventional lithium ion batteries in terms of suppression of elution of aluminum from aluminum-containing current collectors to electrolytic solutions.

### Solution to Problem

The present application discloses a plurality of aspects described below as means for solving the problem.

### Aspect 1

A lithium ion battery, comprising a positive electrode, a negative electrode, and an electrolytic solution, wherein
one or both of the positive electrode and the negative electrode comprise an aluminum-containing current collector,
the electrolytic solution contains
   a cyclic carbonate, and
   a lithium amide salt dissolved in the cyclic carbonate,
      the lithium amide salt contains
      a chain lithium amide salt, and
      a cyclic lithium amide salt,
      a molar ratio of the chain lithium amide salt to the cyclic carbonate is greater than 0.25 and 0.33 or less, and
      a molar ratio of the cyclic lithium amide salt to the cyclic carbonate is greater than 0 and 0.07 or less.

### Aspect 2

The lithium ion battery according to Aspect 1, wherein
at least the positive electrode comprises the aluminum-containing current collector.

### Aspect 3

The lithium ion battery according to Aspect 1 or 2, wherein
the cyclic carbonate is one or both of propylene carbonate and ethylene carbonate.

### Aspect 4

The lithium ion battery according to any of Aspects 1 to 3, wherein
the chain lithium amide salt is one or both of lithium bisfluorosulfonylamide and lithium bistrifluoromethanesulfonylamide.

### Aspect 5

The lithium ion battery according to any of Aspects 1 to 4, wherein
the cyclic lithium amide salt is represented by the following formula (1):

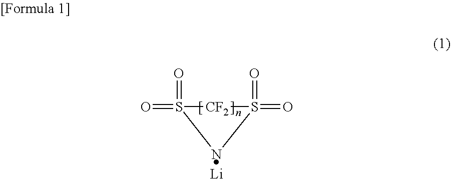

wherein n is an integer of 2 to 5.

### Effects

The lithium ion battery of the present disclosure can be suppressed in elution of aluminum from an aluminum-containing current collector to an electrolytic solution, as compared with the conventional lithium ion batteries.

### BRIEF DESCRIPTION OF DRAWINGS

FIG. 1 schematically shows a configuration of a lithium ion battery.

FIG. 2 shows results of Al corrosion evaluation.

### DESCRIPTION OF EMBODIMENTS

Hereinafter, one embodiment of the lithium ion battery and the like of the present disclosure will be described. However, the lithium ion battery and the like of the present disclosure are not limited to any embodiment described below.

### 1. Lithium Ion Battery

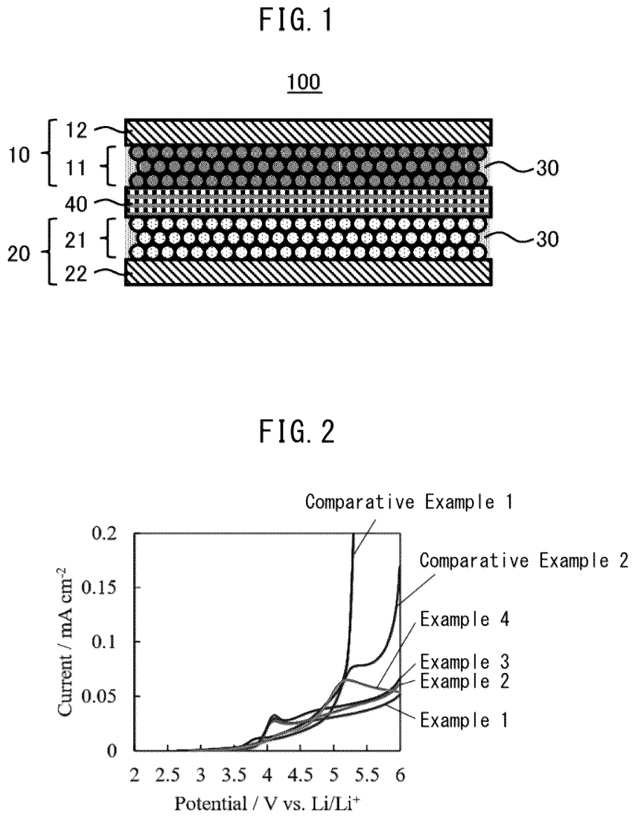

As shown in FIG. 1, a lithium ion battery 100 according to one embodiment comprises a positive electrode 10, a negative electrode 20 and an electrolytic solution 30. One or both of the positive electrode 10 and the negative electrode 20 comprise an aluminum-containing current collector. The electrolytic solution 30 contains a cyclic carbonate and a lithium amide salt dissolved in the cyclic carbonate. The lithium amide salt contains a chain lithium amide salt and a cyclic lithium amide salt. A molar ratio of the chain lithium amide salt to the cyclic carbonate is greater than 0.25 and 0.33 or less. A molar ratio of the cyclic lithium amide salt to the cyclic carbonate is greater than 0 and 0.07 or less.

### 1.1 Positive Electrode

As shown in FIG. 1, the positive electrode 10 according to one embodiment can comprise a positive electrode active material layer 11 and a positive electrode current collector 12. When a negative electrode current collector 22 described below is an aluminum-containing current collector, the positive electrode current collector 12 may or may not be an aluminum-containing current collector. When a negative electrode current collector 22 described below is not an aluminum-containing current collector, the positive electrode current collector 12 is an aluminum-containing current collector. In particular, while elution of aluminum from an aluminum-containing current collector into an electrolytic solution easily occurs at a high potential of an aluminum-containing current collector, the technique of the present disclosure can suppress elution of aluminum into an electrolytic solution 30 even when at least the positive electrode 10 has an aluminum-containing current collector.

### 1.1.1 Positive Electrode Active Material Layer

The positive electrode active material layer 11 comprises a positive electrode active material, and may optionally comprise an electrolyte, a conductive aid, a binder, and various additives. The content of each of the positive electrode active material, electrolyte, conductive aid, and binder in the positive electrode active material layer 11 may be appropriately determined according to the target performance of a battery. For example, the content of the positive electrode active material to the entire positive electrode active material layer 11 (total solid content) as 100% by mass may be 40% by mass or greater, 50% by mass or greater, or 60% by mass or greater, and may be less than 100% by mass, or 90% by mass or less. The shape of the positive electrode active material layer 11 is not particularly limited, and may be, for example, a sheet having a substantially flat surface. The thickness of the positive electrode active material layer 11 is not particularly limited, and may be, for example, 0.1 μm or more, 1 μm or more, 10 μm or more or 30 μm or more, and may be 2 mm or less, 1 mm or less, 500 μm or less, or 100 μm or less.

Any known positive electrode active material for lithium ion batteries can be adopted as the positive electrode active material. Of known active materials, materials having a potential (charge/discharge potential) at which lithium ions are stored and released that is more electropositive than that of the negative electrode active material described below can be used as the positive electrode active material. For example, various lithium-containing composite oxides, such as lithium cobalt oxide, lithium nickel oxide, lithium manganese oxide, lithium manganese-nickel-cobalt oxide, and lithium spinel compounds, can be adopted as the positive electrode active material. One type of positive electrode active material may be used alone, or two or more types thereof may be used in combination. The positive electrode active material may be, for example, particulate, and the size thereof is not particularly limited. The particle of the positive electrode active material may be a solid particle or a hollow particle. The particle of the positive electrode active material may be a primary particle or a secondary particle of a plurality of agglomerated primary particles. The average particle diameter (D50) of the particle of the positive electrode active material may be, for example, 1 nm or more, 5 nm or more, or 10 nm or more, and may be 500 μm or less, 100 μm or less, 50 μm or less, or 30 μm or less. Herein, the average particle diameter (D50) is a particle diameter (D50, median diameter) at which the cumulative value in a particle size distribution on a volume basis according to a laser diffraction/scattering method is 50%.

The surface of the positive electrode active material may be covered by a protective layer containing a lithium ion conductive oxide. Specifically, a composite comprising the above positive electrode active material and a protective layer provided on the surface thereof may be contained in the positive electrode active material layer 11. Examples of the lithium ion conductive oxide include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, and Li₂WO₄. The coverage (area ratio) of the protective layer may be, for example, 70% or greater, 80% or greater, or 90% or greater. The thickness of the protective layer may be, for example, 0.1 nm or more, or 1 nm or more, and may be 100 nm or less, or 20 nm or less.

The positive electrode active material layer 11 may comprise an electrolytic solution 30 described below. The positive electrode active material layer 11 may comprise an additional electrolyte, in addition to the electrolytic solution 30. The additional electrolyte may be a solid electrolyte, an electrolytic solution other than the electrolytic solution 30, or a combination thereof. Any known solid electrolyte for lithium ion batteries may be used as the solid electrolyte. The solid electrolyte may be an inorganic solid electrolyte or an organic polymer electrolyte. Particularly, an inorganic solid electrolyte has excellent ion conductive properties and heat resistance. Sulfide solid electrolytes and oxide solid electrolytes can be exemplified as the inorganic solid electrolyte. Particularly, sulfide solid electrolytes, particularly, sulfide solid electrolytes comprising at least Li, S and P as constituent elements have high performance, and sulfide solid electrolytes based on a Li₃PS₄ framework and comprising at least one halogen have also high performance. The solid electrolyte may be amorphous or crystalline. The solid electrolyte may be, for example, particulate. One type of solid electrolyte may be used alone, or two or more types thereof may be used in combination. An electrolytic solution other than the electrolytic solution 30 (additional electrolytic solution) may comprise, for example, a lithium ion as the carrier ion. The additional electrolytic solution may be, for example, a nonaqueous electrolytic solution. For example, a lithium salt dissolved in a carbonate-based solvent at a predetermined concentration can be used as the electrolytic solution.

Examples of the conductive aid that can be contained in the positive electrode active material layer 11 include carbon materials such as vapor-grown carbon fibers (VGCF), acetylene black (AB), Ketjen black (KB), carbon nanotubes (CNT), and carbon nanofibers (CNF); and metal materials such as nickel, aluminum, and stainless steel. The conductive aid may be, for example, particulate or fibrous, and the size thereof is not particularly limited. One type of conductive aid may be used alone, or two or more types thereof may be used in combination.

Examples of the binder that can be contained in the positive electrode active material layer 11 include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, polyimide (PI)-based binders, and polyacrylic acid-based binders. One type of binder may be used alone, or two or more types thereof may be used in combination.

### 1.1.2 Positive Electrode Current Collector

As shown in FIG. 1, the positive electrode 10 may comprise a positive electrode current collector 12 in contact with the positive electrode active material layer 11 and the electrolytic solution 30. Any material generally used as a positive electrode current collector for lithium ion batteries can be adopted as the positive electrode current collector 12. In addition, the positive electrode current collector 12 may be in the form of a foil, a plate, a mesh, a perforated (punched) metal, or a foam body. The positive electrode current collector 12 may be comprised of a metal foil or a metal mesh. Particularly, a metal foil has excellent handleability. The positive electrode current collector 12 may be formed of a plurality of foils. Examples of the metal constituting the positive electrode current collector 12 include Cu, Ni, Cr, Au, Pt, Ag, Al, Fe, Ti, Zn, Co, and stainless steel. As described above, the positive electrode 10 may comprise an aluminum-containing current collector in contact with the positive electrode active material layer 11 and the electrolytic solution 30, as the positive electrode current collector 12, and in this case, oxidation resistance or the like is easily ensured. For the purpose of adjusting resistance and etc., the surface of the positive electrode current collector 12 may have some coating layer. Further, the above metals may be plated or vapor-deposited onto a metal foil or a substrate for the positive electrode current collector 12. When the positive electrode current collector 12 comprises a plurality of metal foils, some layer may be included between the plurality of metal foils. The thickness of the positive electrode current collector 12 is not particularly limited. The thickness may be, for example, 0.1 μm or more, or 1 μm or more, and may be 1 mm or less, or 100 μm or less.

In addition to the above configuration, the positive electrode 10 may be provided with any configuration generally used for a positive electrode of a lithium ion battery, for example, a tab or a terminal. The positive electrode 10 can be manufactured by applying a known method. For example, the positive electrode active material layer 11 can be easily formed by dry- or wet-molding a positive electrode mixture containing the various components above. The positive electrode active material layer 11 may be molded together with the positive electrode current collector 12 or separately from the positive electrode current collector 12.

### 1.2 Negative Electrode

As shown in FIG. 1, the negative electrode 20 according to one embodiment may comprise a negative electrode active material layer 21 and a negative electrode current collector 22. When the positive electrode current collector 12 described above is an aluminum-containing current collector, the negative electrode current collector 22 may or may not be an aluminum-containing current collector. When the positive electrode current collector 12 described above is not an aluminum-containing current collector, the negative electrode current collector 22 is an aluminum-containing current collector.

### 1.2.1 Negative Electrode Active Material Layer

The negative electrode active material layer 21 comprises a negative electrode active material, and may optionally comprise an electrolyte, a conductive aid, a binder, and various additives. The content of each of the negative electrode active material, electrolyte, conductive aid, and binder in the negative electrode active material layer 21 may be appropriately determined according to the target performance of a battery. For example, the content of the negative electrode active material to the entire negative electrode active material layer 21 (total solid content) as 100% by mass may be 40% by mass or greater, 50% by mass or greater, or 60% by mass or greater, and may be less than 100% by mass, or 90% by mass or less. The shape of the negative electrode active material layer 21 is not particularly limited, and may be, for example, a sheet having a substantially flat surface. The thickness of the negative electrode active material layer 21 is not particularly limited, and may be, for example, 0.1 μm or more, 1 μm or more, 10 μm or more, or 30 μm or more, and may be 2 mm or less, 1 mm or less, 500 μm or less, or 100 μm or less.

Any known negative electrode active material for lithium ion batteries can be adopted as the negative electrode active material. Of known active materials, materials having a potential (charge/discharge potential) at which lithium ions are stored and released that is more electronegative than that of the positive electrode active material described above can be used as the negative electrode active material. For example, silicon-based active materials such as Si, Si alloys, and silicon oxides; carbon-based active materials such as graphite and hard carbon; various oxide-based active materials such as lithium titanate; and metallic lithium and lithium alloys can be adopted as the negative electrode active material. One type of negative electrode active material may be used alone, or two or more types thereof may be used in combination. The negative electrode active material may be, for example, particulate, and the size thereof is not particularly limited. The particle of the negative electrode active material may be a solid particle or a hollow particle. The particle of the negative electrode active material may be a primary particle or a secondary particle of a plurality of agglomerated primary particles. The average particle diameter (D50) of the particle of the negative electrode active material may be, for example, 1 nm or more, 5 nm or more, or 10 nm or more, and may be 500 μm or less, 100 μm or less, 50 μm or less, or 30 μm or less. Alternatively, the negative electrode active material may be in the form of a sheet (foil or film), such as a lithium foil. Specifically, the negative electrode active material layer 21 may consist of a negative electrode active material sheet.

The negative electrode active material layer 21 may comprise an electrolytic solution 30 described below. The negative electrode active material layer 21 may comprise an additional electrolyte, in addition to the electrolytic solution 30. Examples of the additional electrolyte include the solid electrolyte and electrolytic solution described above and a combination thereof. A conductive aid that can be contained in the negative electrode active material layer 21 may be appropriately selected from, for example, conductive aids exemplified as a conductive aid that can be contained in the positive electrode active material layer 11 described above. A binder that can be contained in the negative electrode active material layer 21 may be appropriately selected from, for example, binders exemplified as a binder that can be contained in the positive electrode active material layer 11 described above. For each of the electrolyte, the conductive aid, and the binder, one type may be used alone, or two or more types thereof may be used in combination.

### 1.2.2 Negative Electrode Current Collector

As shown in FIG. 1, the negative electrode 20 may comprise a negative electrode current collector 22 in contact with the negative electrode active material layer 21 and the electrolytic solution 30. Any material generally used as a negative electrode current collector for batteries can be adopted as the negative electrode current collector 22. In addition, the negative electrode current collector 22 may be in the form of a foil, a plate, a mesh, a perforated (punched) metal, or a foam body. The negative electrode current collector 22 may be a metal foil or a metal mesh, and may alternatively be a carbon sheet. Particularly, a metal foil has excellent handleability. The negative electrode current collector 22 may be formed of a plurality of foils or sheets. Examples of the metal constituting the negative electrode current collector 22 include Cu, Ni, Cr, Au, Pt, Ag, Al, Fe, Ti, Zn, Co, and stainless steel. From the viewpoint of ensuring reduction resistance and making alloying with lithium difficult, the negative electrode current collector 22 may comprise at least one metal selected from Cu, Ni, and stainless steel. Alternatively, as described above, the negative electrode 20 may comprise an aluminum-containing current collector in contact with the negative electrode active material layer 21 and the electrolytic solution 30, as the negative electrode current collector 22. For the purpose of adjusting resistance and etc., the surface of the negative electrode current collector 22 may have some coating layer. Further, the above metals may be plated or vapor-deposited onto a metal foil or a substrate for the negative electrode current collector 22. When the negative electrode current collector 22 comprises a plurality of metal foils, some layer may be included between the plurality of metal foils. The thickness of the negative electrode current collector 22 is not particularly limited. The thickness may be, for example, 0.1 μm or more, or 1 μm or more, and may be 1 mm or less, or 100 μm or less.

In addition to the above configuration, the negative electrode 20 may be provided with any configuration generally used for a negative electrode of a lithium ion battery, for example, a tab or a terminal. The negative electrode 20 can be manufactured by applying a known method. For example, the negative electrode active material layer 21 can be easily formed by dry- or wet-molding a negative electrode mixture containing the various components above. The negative electrode active material layer 21 may be molded together with the negative electrode current collector 22 or separately from the negative electrode current collector 22.

### 1.3 Electrolytic Solution

The electrolytic solution 30 contains a cyclic carbonate and a lithium amide salt dissolved in the cyclic carbonate.

### 1.3.1 Cyclic Carbonate

The electrolytic solution 30 contains a cyclic carbonate as the solvent. Cyclic carbonates have a higher dielectric constant than chain carbonates and easily coordinate lithium ions. In other words, in the electrolytic solution 30, a cyclic carbonate does not easily enter into a free state, and consequently, thermal stability easily increases. Particularly, when a lithium amide salt is dissolved in the cyclic carbonate at a predetermined concentration, nearly all of the cyclic carbonate can be solvated with the lithium ions, and as a result, thermal stability can be further improved. In addition, a small amount of lithium ions that are not solvated with the cyclic carbonate increases the transference number of lithium ions even under high viscosity, and excellent lithium ion conductive properties are easily ensured.

The cyclic carbonate is not limited as long as it includes a cyclic structure as the chemical structure, it is a liquid at a temperature at which lithium ion conductive properties are desired to be exhibited, and it is capable of dissolving a lithium amide salt at a predetermined concentration. Specific examples of the cyclic carbonate include propylene carbonate (PC), ethylene carbonate (EC), butylene carbonate (BC), vinylene carbonate (VC), and derivatives thereof (for example, halides). Particularly, when the cyclic carbonate is at least one of propylene carbonate and ethylene carbonate, more excellent lithium ion conductive properties and thermal stability are easily ensured. One type of cyclic carbonate may be used alone, or two or more types thereof may be used in combination.

### 1.3.2 Solvent (Auxiliary Solvent) Other than Cyclic Carbonate

The solvent constituting the electrolytic solution 30 may consist of the above cyclic carbonate, or may comprise a solvent (auxiliary solvent) other than a cyclic carbonate in addition to the above cyclic carbonate. Examples of the auxiliary solvent other than a cyclic carbonate include a chain carbonate. Examples of the chain carbonate include dimethyl carbonate (DMC), diethyl carbonate (DEC), and derivatives thereof (for example, halides, particularly ones having a perfluoroalkyl group). However, chain carbonates have a lower dielectric constant compared to cyclic carbonates and do not tend to coordinate lithium ions easily. Therefore, in the lithium ion conducting material, a chain carbonate easily enters into a free state by itself, and easily volatilizes. In the electrolytic solution 30, when there is a small amount of auxiliary solvent other than a cyclic carbonate, high thermal stability is easily ensured. In the electrolytic solution 30, the molar ratio of the auxiliary solvent to the cyclic carbonate ([auxiliary solvent (mol)]/[cyclic carbonate (mol)]) may be 0.10 or less, 0.05 or less, or 0.03 or less. The lower limit of the molar ratio of the auxiliary solvent to the cyclic carbonate is 0.

### 1.3.3 Lithium Amide Salt

The electrolytic solution 30 comprises a lithium amide salt dissolved in the above cyclic carbonate. The lithium amide salt may be dissolved in the cyclic carbonate and ionized into cations and anions, or may form association units with the cyclic carbonate or the like. The electrolytic solution 30 comprises both a chain lithium amide salt and a cyclic lithium amide salt in the lithium amide salt. Note that, “amide salt” is a concept which also includes “imide salt”.

### 1.3.3.1 Chain Lithium Amide Salt

Specific examples of the chain lithium amide salt include sulfonylamide salts such as lithium bisfluorosulfonylamide (LiFSA, LiN(SO₂F)₂), lithium bistrifluoromethanesulfonylamide (LiTFSA, Li[N(CF₃SO₂)₂]), lithium bisperfluoroethylsulfonylamide (Li[N(C₂F₅SO₂)₂]), lithium bisperfluorobutylsulfonylamide (Li[N(C₄F₉SO₂)₂]), and lithium fluorosulfonyltrifluoromethanesulfonylamide (Li[N(FSO₂)(C₂F₅SO₂)]). Alternatively, silylamide salts having Si in place of S may be adopted. Particularly, when the chain lithium amide salt is at least one or both of lithium bisfluorosulfonylamide (LiFSA, LiN(SO₂F)₂) and lithium bistrifluoromethanesulfonylamide (LiTFSA, Li[N(CF₃SO₂)₂]), more excellent lithium ion conductive properties and thermal stability are easily ensured. One type of chain lithium amide salt may be used alone, or two or more types thereof may be used in combination.

The molar ratio of the chain lithium amide salt to the cyclic carbonate ([chain lithium amide salt (mol)]/[cyclic carbonate (mol)]) is greater than 0.25 and 0.33 or less. In other words, the chain lithium amide salt is dissolved at a concentration of more than 0.25 mol and 0.33 mol or less per mol of cyclic carbonate. When the concentration of chain lithium amide salt in the cyclic carbonate is in this range, thermal stability and lithium ion conductive properties are likely to be remarkably improved. When the concentration of chain lithium amide salt with respect to the cyclic carbonate is too low, thermal stability and lithium ion conductive properties do not easily improve. When the concentration of chain lithium amide salt with respect to the cyclic carbonate is excessive, viscosity becomes too high, and there is a risk of deterioration of the lithium ion conductive properties. The molar ratio may be 0.26 or greater, 0.27 or greater, or 0.28 or greater, and may be 0.32 or less, 0.31 or less, or 0.30 or less. The molar ratio of the chain lithium amide salt to the cyclic carbonate can be specified by analyzing the ions and elements contained in the cyclic carbonate.

### 1.3.3.2 Cyclic Lithium Amide Salt

According to the new findings of the present inventor, when an electrolytic solution for lithium ion batteries comprises only a chain lithium amide salt together with the above carbonate solvent, aluminum easily elutes from an aluminum-containing current collector to the electrolytic solution. The present inventor have advanced intensive studies in order to solve the above problems, and thus have found that elution of aluminum from an aluminum-containing current collector into an electrolytic solution can be suppressed by dissolving not only a chain lithium amide salt, but also a cyclic lithium amide salt in the electrolytic solution 30 of the lithium ion battery 100. Specifically, when not only the above chain lithium amide salt, but also a cyclic lithium amide salt is dissolved in the electrolytic solution 30, a coating film derived from the cyclic lithium amide salt is formed on the surface of the above aluminum-containing current collector in contact with the electrolytic solution 30. The coating film functions as a protective film that suppresses elution of aluminum from the aluminum-containing current collector into the electrolytic solution 30.

Specific examples of the cyclic lithium amide salt include the above sulfonylamide salts or silylamide salts in which sulfonylamide groups or silylamide groups form a ring via a perfluoroalkylene group or the like. Particularly, according to the new findings of the present inventor, when the cyclic lithium amide salt is represented by the following formula (1), elution of aluminum can be more remarkably suppressed.

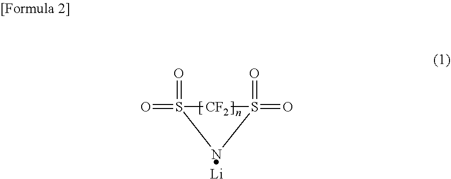

In the formula (1), n is an integer of 2 to 5. n may be an integer of 2 to 4, or may be 3.

The molar ratio of the cyclic lithium amide salt to the cyclic carbonate ([cyclic lithium amide salt (mol)]/[cyclic carbonate (mol)]) is greater than 0 and 0.07 or less. In other words, the cyclic lithium amide salt is dissolved at a concentration of more than 0 mol and 0.07 mol or less per mol of cyclic carbonate. When the concentration of cyclic lithium amide salt in the cyclic carbonate is in this range, not only the aluminum elution suppression effect, but also excellent thermal stability and lithium ion conductive properties can be ensured. The molar ratio may be 0.01 or greater, 0.02 or greater, or 0.03 or greater, and may be 0.06 or less, 0.05 or less, or 0.04 or less. The molar ratio of the cyclic lithium amide salt to the cyclic carbonate can be specified by analyzing the ions and elements contained in the cyclic carbonate.

### 1.3.4 Lithium Salt Other than Lithium Amide Salt

In the electrolytic solution 30, the lithium salt dissolved in the solvent may consist of the above lithium amide salt, or may be a combination of the above lithium amide salt and a lithium salt (additional lithium salt) other than a lithium amide salt. In either case, as long as the above chain lithium amide salt and cyclic lithium amide salt are dissolved at each predetermined concentration with respect to the cyclic carbonate, not only excellent thermal stability and ion conductive properties are ensured, but also elution of aluminum from an aluminum current collector into the electrolytic solution 30 can be suppressed. In the electrolytic solution 30, it is preferred that the ratio of a lithium amide salt in the lithium salts dissolved in the solvent be higher. Specifically, the ratio of the lithium amide salt in all (100 mol %) of the lithium salts may be 50 mol % or greater, 60 mol % or greater, 70 mol % or greater, 80 mol % or greater, 90 mol % or greater, 95 mol % or greater, or 99 mol % or greater.

### 1.3.5 Additional Optional Components

The electrolytic solution 30 may comprise various additives, in addition to the above solvent and lithium amide salt, as long as the above problems can be solved. The type of additive can be selected according to the intended performance. The electrolytic solution 30 may be combined with a solid material (for example, solid electrolyte).

### 1.4 Additional Features

The lithium ion battery 100 may have a separator 40 between the positive electrode 10 and the negative electrode 20, and the above electrolytic solution 30 may be retained in the separator 40. Any known separator for the lithium ion battery 100 can be adopted as the separator 40. The lithium ion battery 100 may be a battery in which each of the above components is housed inside an outer packaging. Any known outer packaging for batteries can be adopted as the outer packaging. In addition, a plurality of lithium ion batteries 100 may be optionally electrically connected and optionally stacked to form a battery pack. In this case, the battery pack may be housed inside a known battery case. The lithium ion battery 100 may additionally comprise obvious components such as the necessary terminals. Examples of a shape of the lithium ion battery 100 may include a coin, a laminate, a cylinder, and a rectangle. The lithium ion battery 100 may be a secondary battery. The lithium ion battery 100 can be manufactured by applying a known method, for example, the following method. However, the method for manufacturing the lithium ion battery 100 is not limited to the following method, and each layer may be formed by, for example, dry molding.
(1) A positive electrode active material constituting a positive electrode active material layer is dispersed in a solvent to obtain a positive electrode slurry. The solvent used in this case is not particularly limited, and water and various organic solvents can be used. The positive electrode slurry is applied to a surface of a positive electrode current collector using a doctor blade and then dried to form a positive electrode active material layer on the surface of the positive electrode current collector to obtain a positive electrode.
(2) A negative electrode active material constituting a negative electrode active material layer is dispersed in a solvent to obtain a negative electrode slurry. The solvent used in this case is not particularly limited, and water and various organic solvents can be used. The negative electrode slurry is applied to a surface of a negative electrode current collector using a doctor blade and then dried to form a negative electrode active material layer on the surface of the negative electrode current collector to obtain a negative electrode.
(3) The layers are laminated such that an electrolyte layer (separator) is interposed between the negative electrode and the positive electrode, in the order of negative electrode current collector, negative electrode active material layer, electrolyte layer, positive electrode active material layer and positive electrode current collector, to obtain a laminated body. Additional members such as terminals are attached to the laminated body as needed.
(4) The laminated body is housed in a battery case, and the laminated body is immersed in an electrolytic solution and the laminated body is sealed in the battery case to obtain a lithium ion battery. The electrolytic solution may be included in the negative electrode active material layer, the separator, and the positive electrode active material layer in the above step (3).

### 2. Lithium Ion Conducting Material

The technique of the present disclosure has an aspect of a lithium ion conducting material. Specifically, the lithium ion conducting material of the present disclosure comprises a cyclic carbonate and a lithium amide salt dissolved in the cyclic carbonate, wherein the lithium amide salt contains a chain lithium amide salt and a cyclic lithium amide salt, a molar ratio of the chain lithium amide salt to the cyclic carbonate is greater than 0.25 and 0.33 or less, and a molar ratio of the cyclic lithium amide salt to the cyclic carbonate is greater than 0 and 0.07 or less. The detail of each of the components constituting the lithium ion conducting material is as described above.

### 3. Vehicle

The lithium ion battery of the present disclosure can be suitably used in, for example, at least one vehicle selected from a hybrid electric vehicle (HEV), a plug-in hybrid electric vehicle (PHEV), and a battery electric vehicle (BEV). Specifically, the technique of the present disclosure also has an aspect of a vehicle comprising a lithium ion battery, wherein the lithium ion battery has a positive electrode, a negative electrode, and an electrolytic solution, one or both of the positive electrode and the negative electrode comprise an aluminum-containing current collector, the electrolytic solution contains a cyclic carbonate and a lithium amide salt dissolved in the cyclic carbonate, the lithium amide salt contains a chain lithium amide salt and a cyclic lithium amide salt, a molar ratio of the chain lithium amide salt to the cyclic carbonate is greater than 0.25 and 0.33 or less, and a molar ratio of the cyclic lithium amide salt to the cyclic carbonate is greater than 0 and 0.07 or less.

### EXAMPLES

Hereinafter, the technique of the present disclosure will be described in detail with references to the Examples, but the technique of the present disclosure is not limited to the following Examples.

### 1. Production of Electrolytic Solution

### 1.1 Comparative Example 1

Propylene carbonate (PC) as the solvent and lithium bisfluorosulfonylamide (LiFSA) as the chain lithium amide salt were each weighed to obtain a molar ratio of 0.33 (PC:LiFSA=3:1), and then mixed and stirred to obtain an electrolytic solution according to Comparative Example 1.

### 1.2 Example 1

PC, LiFSA, and lithium 1,1,2,2,3,3-hexafluoropropane-1,3-disulfonimide (LiCFSA, the following formula (Ia)) as the cyclic lithium amide salt were each weighed to obtain a molar ratio of LiFSA to PC of 0.33 (PC:LiFSA=3:1) and a molar ratio of LiCFSA to PC of 0.033 (PC:LiCFSA=3:0.1), and then mixed and stirred to obtain an electrolytic solution according to Example 1.

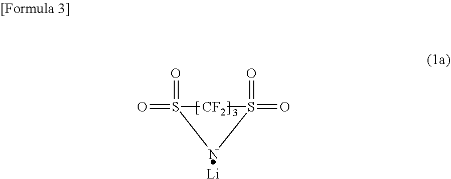

### 1.3 Example 2

PC, LiFSA, and LiCFSA as the cyclic lithium amide salt were each weighed to obtain a molar ratio of LiFSA to PC of 0.30 (PC:LiFSA=3.3:1) and a molar ratio of LiCFSA to PC of 0.030 (PC:LiCFSA=3.3:0.1), and then mixed and stirred to obtain an electrolytic solution according to Example 2.

### 1.4 Example 3

PC, LiFSA, and LiCFSA were each weighed to obtain a molar ratio of LiFSA to PC of 0.25 (PC:LiFSA=4:1) and a molar ratio of LiCFSA to PC of 0.025 (PC:LiCFSA=4:0.1), and then mixed and stirred to obtain an electrolytic solution according to Example 3.

### 1.5 Comparative Example 2

PC and lithium bis(trifluoromethane) sulfonylamide (LiTFSA) as the chain lithium amide salt were each weighed to obtain a molar ratio of LiTFSA to PC of 0.33 (PC:LiTFSA=3:1), and then mixed and stirred to obtain an electrolytic solution according to Comparative Example 2.

### 1.6 Example 4

PC, LiFSA, and LiCFSA were each weighed to obtain a molar ratio of LiFSA to PC of 0.33 (PC:LiTFSA=3:1) and a molar ratio of LiCFSA to PC of 0.033 (PC:LiCFSA=3:0.1), and then mixed and stirred to obtain an electrolytic solution according to Example 4.

### 2. Evaluation of Ionic Conductivity

In a bipolar target cell wherein Li metal was used for the electrode and the distance between the electrodes was fixed, the value of resistance was measured by an AC impedance method at 25° C. The ionic conductivity was calculated from the resulting value of resistance and the cell shape (electrode area, distance between electrodes). Specific measurement conditions are as follows.

Measurement conditions: temperature 25° C., amplitude 10 mV, frequency 1 M to 10 mHz

### 3. Evaluation of Al Corrosivity

A half-cell was produced with an Al foil as a working electrode, a Li metal as a counter electrode, and each electrolytic solution according to the above Examples and Comparative Examples, and whether or not there was elution of Al into the electrolytic solution (Al corrosivity) was evaluated by linear sweep voltammetry (LSV measurement). Specific measurement conditions are as follows.

Measurement conditions: sweep rate 10 mV/s, from OCV to 6 V

### 4. Evaluation Results

Table 1 below shows the composition and the ionic conductivity, and the presence of an Al corrosion behavior, with respect to each electrolytic solution according to Examples 1 to 4 and Comparative Examples 1 to 2. FIG. 2 shows LSV measurement results with respect to each of Examples 1 to 4 and Comparative Examples 1 to 2.

TABLE 1

| | | Ionic conductivity | Presence of |
|---|---|---|---|
| | Composition of | (25° C.) | Al corrosion |
| | electrolytic solution | [S/cm] | behavior |
| Comparative | PC/LiFSA = 3/1 | 2.6E−03 | Presence |
| Example 1 | | | |
| Example 1 | PC/LiFSA/LiCFSA = | 2.0E−03 | Absence |
| | 3/1/0.1 | | |
| Example 2 | PC/LiFSA/LiCFSA = | 2.4E−03 | Absence |
| | 3.3/1/0.1 | | |
| Example 3 | PC/LiFSA/LiCFSA = | 3.3E−03 | Absence |
| | 4/1/0.1 | | |
| Comparative | PC/LiTFSA = 3/1 | 1.3E−03 | Presence |
| Example 2 | | | |
| Example 4 | PCJLiTFSA/LiCFSA = | 9.2E−04 | Absence |
| | 3/1/0.1 | | |

As clear from the results shown in Table 1, each of the electrolytic solutions according to Examples 1 to 4 and Comparative Examples 1 to 2 had a high ionic conductivity. As clear from the results shown in FIG. 2, when LSV measurement was conducted with each of the electrolytic solutions according to Comparative Examples 1 and 2, an increase in current due to elution of Al was confirmed. On the contrary, when LSV measurement was conducted with each of the electrolytic solutions according to Examples 1 to 4, an increase in current due to elution of Al was suppressed. It was considered for each of Examples 1 to 4 that a coating film derived from LiCFSA was formed on the surface of the Al foil and functioned as a protective film for suppression of Al elution.

### 5. Conclusion

From the above results, it is considered that, when a lithium ion battery is formed with an electrolytic solution having the following features (1) to (4), elution of aluminum from an aluminum-containing current collector into an electrolytic solution can be suppressed.
(1) The electrolytic solution comprises a cyclic carbonate and a lithium amide salt dissolved in the cyclic carbonate.
(2) The lithium amide salt contains a chain lithium amide salt and a cyclic lithium amide salt.
(3) A molar ratio of the chain lithium amide salt to the cyclic carbonate is greater than 0.25 and 0.33 or less.
(4) A molar ratio of the cyclic lithium amide salt to the cyclic carbonate is greater than 0 and 0.07 or less.

### REFERENCE SIGNS LIST

10 Positive electrode
11 Positive electrode active material layer
12 Positive electrode current collector
20 Negative electrode
21 Negative electrode active material layer
22 Negative electrode current collector
30 Electrolytic solution
40 Separator
100 Lithium ion battery

1. A lithium ion battery, comprising a positive electrode, a negative electrode, and an electrolytic solution, wherein
one or both of the positive electrode and the negative electrode comprise an aluminum-containing current collector,
the electrolytic solution contains
a cyclic carbonate, and
a lithium amide salt dissolved in the cyclic carbonate,
the lithium amide salt contains
a chain lithium amide salt, and
a cyclic lithium amide salt,
a molar ratio of the chain lithium amide salt to the cyclic carbonate is greater than 0.25 and 0.33 or less, and
a molar ratio of the cyclic lithium amide salt to the cyclic carbonate is greater than 0 and 0.07 or less.

2. The lithium ion battery according to claim 1, wherein
at least the positive electrode comprises the aluminum-containing current collector.

3. The lithium ion battery according to claim 1, wherein
the cyclic carbonate is one or both of propylene carbonate and ethylene carbonate.

4. The lithium ion battery according to claim 1, wherein
the chain lithium amide salt is one or both of lithium bisfluorosulfonylamide and lithium bistrifluoromethanesulfonylamide.

5. The lithium ion battery according to claim 1, wherein
the cyclic lithium amide salt is represented by the following formula (1): 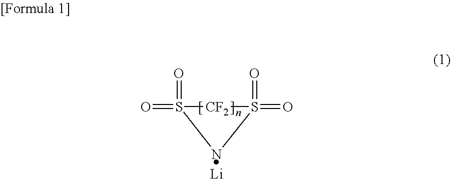
wherein n is an integer of 2 to 5.
